(19) United States
(12) Patent Application Publication
(10) Pub. No.: US 2012/0290275 A1
(43) Pub. Date: Nov. 15, 2012

(54) DEVICE FOR FORMULATING A DEFINITION OF A VERSION OF A PRODUCT

(75) Inventor: Jérôme AMILHASTRE, Pinsaguel (FR)

(73) Assignee: CAMELEON SOFTWARE, Labege Cedex (FR)

(21) Appl. No.: 13/467,106

(22) Filed: May 9, 2012

(30) Foreign Application Priority Data
May 10, 2011 (FR) 11.01425

(51) Int. Cl. G06F 17/50

(52) U.S. Cl. 703/2

(57) ABSTRACT

A device (1) for formulating—on the basis of a data-processing numerical model including several variables, the assuming of values of which is subject to predetermined constraints—a definition of a version of a product. Such a device is suitable to permit a user to effect selections of values to be assigned to each variable, and is suitable to authorize the modification of a value assigned to a variable at the time of a previous selection. Such a device is, in addition, suitable to present to the user the set of the possible values of each variable, taking account of the constraints linking it with the other variables, notably with those which already possess assigned values.

The invention concerns a device for formulating—on the basis of a data-processing numerical model including components, variables to be assigned values, and constraints—a combination of numerical data that is representative of at least one version of a product to be fabricated, in particular a manufactured product, or a service, in particular a contract, having variants and options.

In numerous applications such a known device includes a man/machine interface that is suitable to permit a user to view values to be selected for each variable, and to select those which correspond to the version of the desired product. Such a device most often includes a selection-validation module that is suitable only to authorize assignments of values with respect to variables that are compatible with all the current assignments.

Throughout the text, the term ‘selection’ and its derivatives designate the act for a user of choosing the value of a variable, the term ‘validation’ and its derivatives designate the act for the device according to the invention of verifying whether a selection is admissible or not, and the term ‘assignment’ and its derivatives designate the act for the device according to the invention of authorizing a selection (validated or not) and of recording the value thus selected for the variable.

In practice, these known devices permit, for example, the definition and use of complex models that are representative of manufactured products, such models being capable of including numerous variables, in particular several thousands of variables, and also numerous constraints, in particular several hundred.

Consequently, recourse to such data-processing devices is indispensable in order to check that each choice (assignment of a value to a variable) complies with the constraints of the model and ultimately permits a feasible version of a product to be defined.

The constraints of a data-processing numerical model of a product link between themselves a plurality of variables and define the mutually compatible or incompatible values for the variables that they constrain, thus restricting the range of values that each variable can assume as a function of the values of the other variables.

The selection-validation module of such a known device is suitable to determine whether each value selection for a variable complies with the constraints of the model, in particular in view of the assignments effected with respect to other variables impacting on said selection by means of at least one constraint.

Such a device for formulating a definition of a version of a product often includes a constraint-verification module that is suitable to implement a filtering of the values of the range of validity of a variable. The set of the filtered values, called the compatible values, is determined, on the one hand, from the constraints of the model and, on the other hand, from the current assignments of the other variables of the model. The set of the compatible values for a variable is called the compatible range.

The selection-validation module of such a device is suitable to assign the selected value(s) to the corresponding variable and is also suitable to permit a user to modify a previously effected assignment of a variable.

A problem arises in order to determine the values having to be proposed to the user at the time of each selection for a new assignment or an assignment modification for a variable. In fact, it is not easy (but it is desirable) to distinguish: firstly, values of the variable that are prohibited because of the assignments of values to other variables, which have occurred prior to that of the variable to be modified; secondly, values of the variable that are prohibited by reason of the assignment effected previously with respect to this variable to be modified and by reason of the constraints that have been propagated with respect to the other variables and then with respect to this variable, on account of this prior assignment; and thirdly, values that are prohibited by reason of the interaction of the previously effected assignment in respect of the variable to be modified with the other variables and for which assignments have occurred after that of the variable to be modified. The values of interest to be proposed to the user are in fact the compatible values as well as, amongst the incompatible values, those, the incompatibility of which is only explained with the aid of the previously implemented assignment with respect to the variable—in this case the future new choice actually eliminates the incompatibility.

In order to calculate the compatible values, one might envisage utilizing a filtering of global coherence permitting a guarantee to be given that all the filtered values can be used and they all permit a coherent version of the product to be arrived at that complies with the entirety of the constraints. In practice, this filtering of global coherence is not possible. It is too costly in calculation-time and may even turn out to be unfeasible (by not converging in a reasonable time) for complex models. In order to converge more rapidly, it is necessary to limit the level of verification of constraints by using algorithms that are simplified but imperfect because they do not offer the guarantee of global filtering.

An alternative to the various filtering methods, employed by known devices, consists in determining in advance, and then in storing in a table, the set of the possible combinations of values of the variables combined amongst themselves that satisfy the constraints of the model. According to this method, when a user wishes to modify a value assigned to a variable a constraint-verification module is suitable to filter amongst all the entries of the table those which contain the assignments of the other variables, thus generating the set of the compatible values for the variable to be modified. However, in practice this approach is not realistic for current models that comprise numerous variables. In fact, with this approach the calculation-time for establishing the table, the memory-size for storing the set of the combinations found, and the time for running through the table in order to filter all the compatible values may vary exponentially in relation to the size of the model.

The known devices, such as described in the publication XP 002669920 “Explications et aide à la restauration de la coherence dans les CSP interactifs: application à la confuguration”, Actes des 5èmes Journées Nationales sur la Résolution Pratique de Problèmes NP—Complets (J.N.P.C.'00), Marseille, Amilhastre et al., present to the user a set of values that have been calculated as compatible (according to the chosen filtering method) for each variable, but without distinction for the assigned variables between the prohibited values independently of the current assignment of the variable or because of this current value. In particular, the aforementioned publication is only directed at the problems of the maintenance of coherence and of the propagation of the choices, by permitting a certain aid to the restoration of coherence in the event of detected incoherence and by giving assistance with respect to the operations to be effected in this sense, which may consist in indicating releasing a previously selected variable.

Thus, with these known devices it is, in practice, impossible to modify with reliability the assignment implemented with respect to a variable after effecting assignments with respect to other variables while being and remaining compatible with all the constraints.

The invention aims to overcome these drawbacks. The invention aims, more particularly, to propose a device that is suitable to permit a user to modify an assignment of a variable by determining, in a time that is compatible with utilization on an industrial scale and with current commercial data-processing means, the totality of the values of the variable that are alternative values for a new selection and compatible with the constraints of a model capable of including a large number of variables, in particular several thousands of variables.

The invention aims, more particularly, to propose such a device in which the mean duration of determination of said alternative and compatible values at the time of the selection of a variable is shorter than a few seconds, in particular shorter than one second, with a model capable of including several thousands of variables and constraints and with data-processing resources including at least one microprocessor clocked at a frequency of less than 4 GHz, and a size of random-access memory less than 3 Gb.

In order to do this, the invention concerns a device for formulating a combination of numerical data that is representative of a version of a product on the basis of a data-processing numerical model that is representative of a plurality of versions of said product, said data-processing numerical model comprising functional components, variables and constraints, said device comprising:
at least one man/machine interface,
stored data that are representative of a plurality of predetermined variables with respect to which assignments have to be effected,
for each variable, stored data that are representative of a plurality of values capable of being assigned to this variable by selection by a human operator via said man/machine interface independently of the constraints linked to assignments implemented previously,
stored data, called the state of the assignments, that are representative at each instant of the values already assigned at this instant to variables,
stored data that are representative of predetermined constraints,
a constraint-verification module that is suitable to determine, from said data that are representative of said predetermined constraints, and for each variable, the range, called the compatible range, of the values, called the compatible values, capable of being selected for said variable without infraction of said constraints,

wherein:
the constraint-verification module is also suitable to determine, at least before each selection by a human operator for a variable, called the captured variable, a set, called the possible range, of values, called the alternative values, capable of being selected by a human operator for said captured variable and compatible, by application of said predetermined constraints, with each assignment of a value for each other variable, distinct from the captured variable, this determination being implemented on the basis of said state of the assignments and by application of said predetermined constraints for each other variable that is distinct from the captured variable, and, ignoring whether it exists, the value assigned at the time of a previous selection for said captured variable,
the device is suitable to present, via the man/machine interface, said possible range for each selection of a variable.

The constraint-verification module is preferably suitable to calculate and update the possible range for all the variables that are accessible for a selection—in particular, that are displayed—at a given instant to the user after each action (selection, assignment or assignment modification) effected by said user with respect to at least one of said accessible variables. In a variant, there is nothing to prevent making provision that this updating be effected upon prior command of the user or solely for said captured variable chosen by the user in order to effect a selection.

Advantageously and according to the invention, the constraint-verification module is suitable to define the possible range by determining the compatible values of the captured variable, ignoring:
on the one hand, the value assigned at the time of a previous selection for said captured variable,
on the other hand, the consequences on the compatible or possible ranges of the other variables by propagation of constraints, which is triggered by this previous assignment.

Advantageously, the constraint-verification module is suitable to determine, for each captured variable, from the data that are representative of the state of the assignments of the variables, on the one hand, which are the other variables that influence the possible range of said captured variable and, on the other hand, which other variables are influenced by the assignment of the captured variable. Thus, if a user wishes to modify an assignment of a captured variable the constraint-verification module is suitable to calculate very rapidly, from a subset of variables that influence the range of values of the captured variable (the captured variable considered being excluded from this range), an exhaustive set of possible values of the captured variable. Preferably and according to the invention, this new set of alternative values (possible range) is calculated for each variable currently displayed and proposed to the user after each choice of the user with respect to one of these variables. On the other hand, for a variable not displayed this calculation may be deferred until the moment when it will be displayed and proposed to the user.

It is to be noted that, for a variable not yet assigned, the compatible range is identical to the possible range. On the other hand, for a variable already assigned a value the possible range is determined as if the variable had not yet been assigned (including taking into account the modifications of the compatible ranges of the other variables induced by the fact that this captured variable is no longer assigned), and by taking account of all the assignments of the other variables of the model that have taken place after the earlier assignment of this variable. All the values of the possible range are, in fact, values that the user can select at the time of a modification of an assignment while being sure that this assignment will not bring about any violation of constraints, and that it is compatible with the assignments effected with respect to the other variables.

In addition, in a device according to the invention the possible range presented to a user comprises values to be selected for a variable that comply with all the constraints of the model, taking account of the values already assigned to other variables, but ignoring, if it exists, the value assigned to the captured variable (and its consequences on the compatible ranges of the other variables and those which result therefrom on the compatible range of this captured variable). Thus, the possible range may include non-compatible values when the captured variable has already been the object of an assignment. It is in fact a characteristic of a device according to the invention to authorize the selection of a non-compatible possible value, the lack of compatibility being determined after selection and assignment, the assignment being capable of being maintained by the user, the lack of compatibility being capable of being resolved by another action with respect to another variable, for example.

Thus, a device according to the invention advantageously also includes an assignment-validation module that is suitable to be able to:
record as value assigned to the captured variable any selection for the captured variable effected in the possible range,
determine whether the assignment of a value for a captured variable satisfies said predetermined constraints and, in the negative, produce a warning message via the man/machine interface.

Advantageously, the device according to the invention is characterized in that the assignment-validation module is suitable to permit several successive modifications of a value assigned to a captured variable.

Furthermore, advantageously and according to the invention the constraint-verification module is suitable to update, after each selection of an assigned value for a captured variable, the possible range of each other variable by propagation of the constraints, step by step, to all the variables linked by at least one constraint to the captured variable.

Advantageously and according to the invention, the constraint-verification module is suitable to present via the man/machine interface, in a predetermined order, the possible ranges of values capable of being selected for various variables, and so that the selections can be effected in any order with respect to the various variables. The device is capable of being adapted to the order of the choices of a user without this taking significantly more time than by following a predetermined order of selections presented by the device.

Thus, as long as the definition of the set of the version is not completed, the assignment of a value to a variable is only temporary and may therefore be modified by a user several times and in any order without the device being either perturbed or slowed down in its operation. In addition, a user wishing to modify a choice can redo the same choice or modify it, and can do this an unlimited number of times. Such a flexibility of the device does not penalize its speed of assignment (even if the speed of the calculation of the possible range may be different, according to the constraints and the moment when the user effects a selection in respect of the variable in relation to the seniority of the previous assignment of the variable). The time of calculation of the possible range is, in practice, always sufficiently short—in particular, shorter than one second—to not be perceptible by the user. The precision of the result is guaranteed in all circumstances, according to the precision of the type of algorithm being utilized for the propagation of the constraints.

The device according to the invention is sufficiently generic to function indiscriminately, without perceptible impact on the speed of filtering of the data, whatever the size and type of the values to be selected for a variable, such as: a unique value, a range of contiguous values, a set of not necessarily contiguous values, or other. For example, if a variable corresponds to a date of delivery of a mechanical part necessary for the fabrication of a car, the values to be selected for this variable may be either one day precisely, or a temporal range (a week, a month), or a certain number of days chosen individually from a calendar, or a combination of these possibilities. Only the number of values of the possible range possibly influences the speed of filtering.

Advantageously, in a device according to the invention the stored data that are representative of values assigned to variables are stored in permanent memory.

A device according to the invention permits a user to split up in time the sessions of sequential selections of values while retaining in permanent memory solely the significant data of the version of the model in the process of elaboration. Advantageously, all the unassigned values can be found quickly by the device. Thus, the device implements an optimal compromise between the volume of the stored data and the time of retrieval of the unassigned values.

Advantageously, a device according to the invention operates indiscriminately when the stored data, the modules (the assignment-validation module, the constraint-verification module etc.) and the man/machine interface are situated locally on the same computer (for example, on a portable computer) or are geographically remote and linked by communication links within a network (company network or Internet) and accessible via a computer.

Other characteristics, objectives and advantages of a data-processing device according to the invention will become apparent upon reading the following description which presents, by way of non-limiting example, an embodiment of the invention with reference to the Figures:

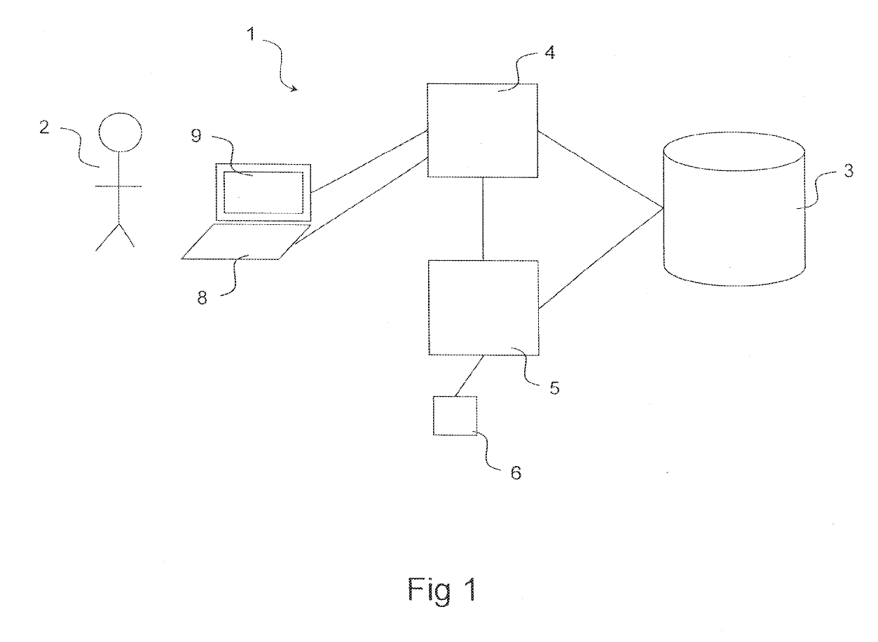

FIG. 1 is a schematic view of an example of a data-processing device according to the invention,

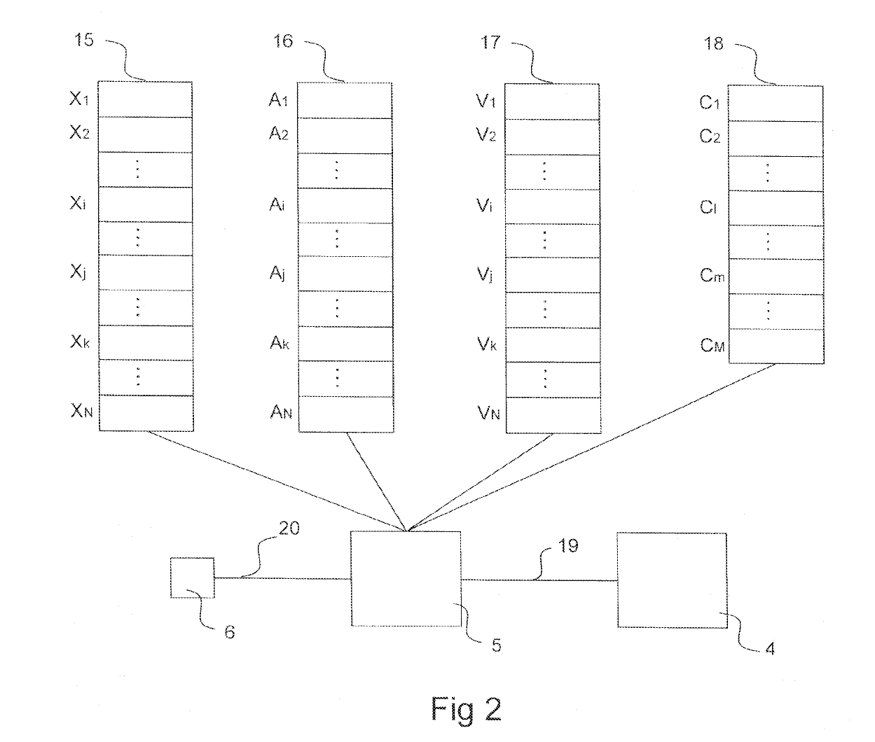

FIG. 2 is a schematic view of an embodiment of an internal structure of a device according to the invention,

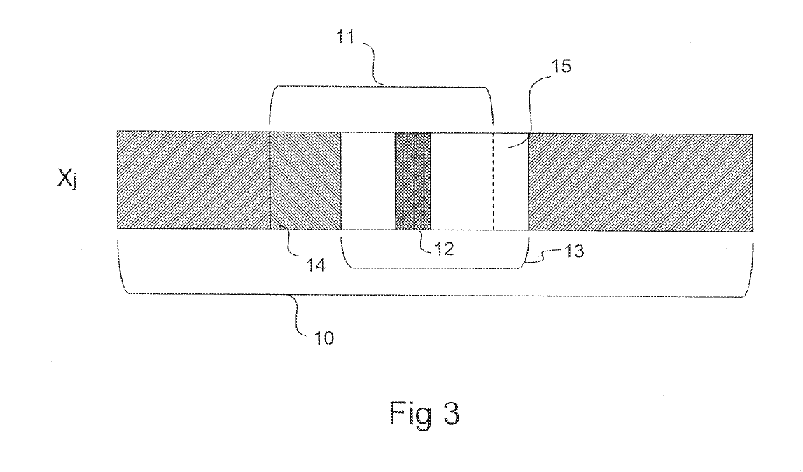

FIG. 3 is a schematic view of an example of the various categories of ranges of values of a variable,

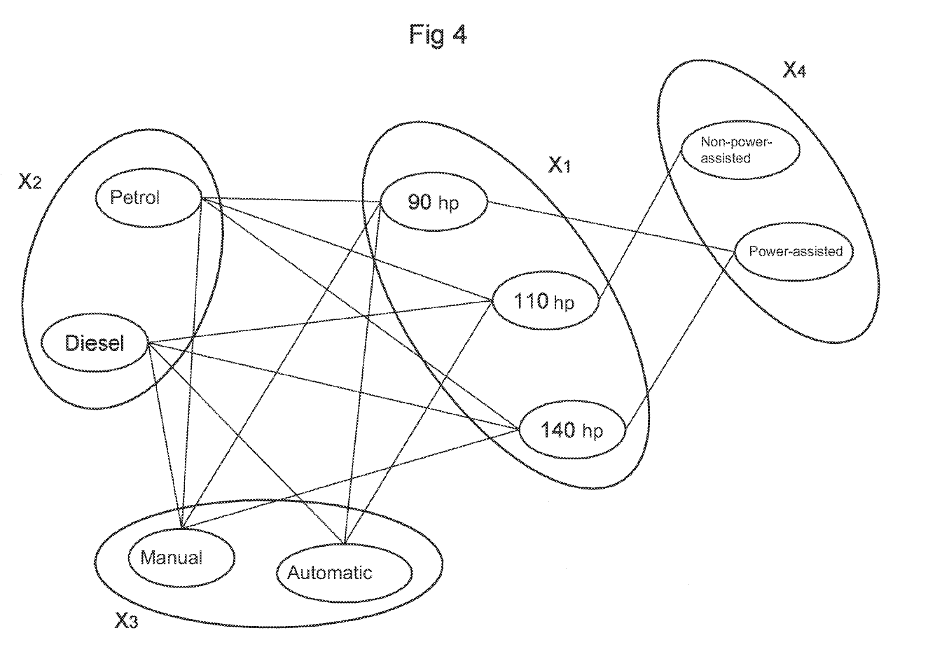

FIG. 4 is a graphic representing an example of links between three variables in an example of a data-processing numerical model capable of being used in a device according to the invention,

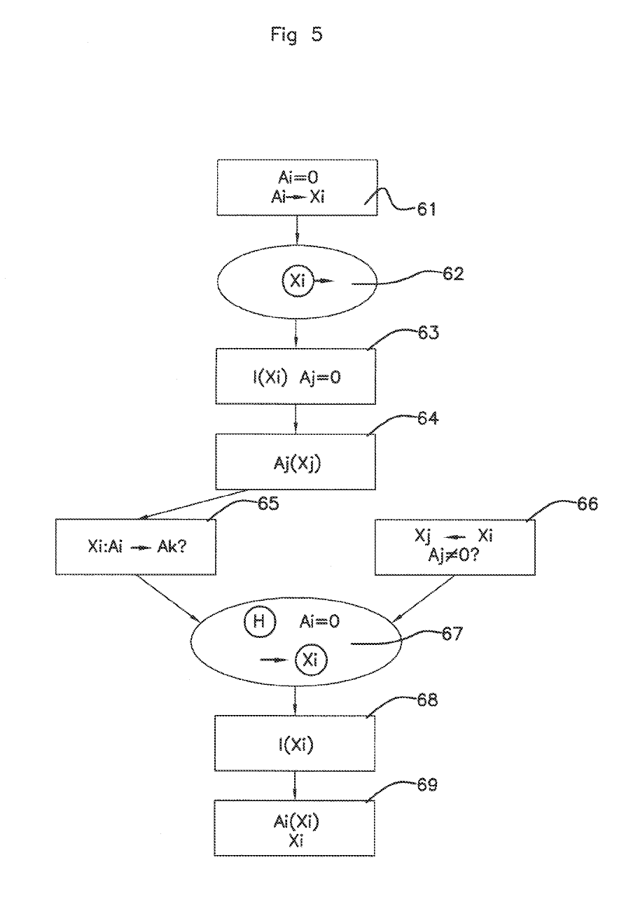

FIG. 5 is a flow chart of successive steps that are executed for the propagation of the constraints in a device according to an embodiment of the invention.

A configurable product is defined by a set of variables for which various values—or options—may be chosen. A set of rules, expressed in a predetermined formalism, defines the relations between the various values or options. For example, each product may be represented by a network of constraints, the solutions of which are the products capable of being fabricated. Within the scope of a process for interactive configuration the automatic generation of solutions is not pertinent: it is in fact the user who fixes, in totality or partially, the values of the variables, at the end of a sequence of selections (choices), each selection of a value for a variable being comparable to a so-called unary constraint, that is to say, one which relates only to this variable and only authorizes this value. In this context, the role of a device according to the invention is to ensure that the selections of the user are coherent with the underlying rules. Such a device permits the user to be guided and permits the set of his/her selections to be validated without resulting in an impasse. If an incoherence appears, the device according to the invention has to help the user to find a coherent relaxation of his/her selections. A device according to the invention must also, in a situation of coherence, help the user to modify a selection while remaining coherent.

The so-called CSP (constraint-satisfaction-problem) approach offers a general framework of representation for numerous problems for aiding the decision.

A product may be represented by a network of constraints. The variables codify the various components, options and attributes of the product, and the constraints are the rules of feasibility, of compatibility between components, of preference, etc. The variables are of finite range, and the product is represented by a conjunction of constraints. The set of the solutions of the CSP forms the catalogue, that is to say, constitutes the set of the variants of the product that can effectively be implemented, in particular fabricated and sold to a client. In a configuration situation the user defines the product that he/she desires by selecting interactively values for the variables or, more generally, by introducing unary constraints. After each selection the ranges have to be filtered in such a manner as to guarantee coherence (ideally, global coherence) with the assignments already effected. Lastly, if the set of the assignments effected is incoherent with the constraints of the CSP or if the remaining values do not suit him/her, the user must be able to go back over his/her previous selections and suppress them or modify them.

A device according to the invention must, in particular, provide:
a maintenance of coherence: it is a matter of guaranteeing that the set of selections is coherent at any instant with the network of constraints modeling the product, or, failing that, of detecting the incoherence as soon as possible. It is also a matter of reflecting the consequences of the actions of the user by prohibiting (respectively, by restoring) the values that are incompatible (respectively, compatible) with his/her selections,
an aid to changing: it is a matter of proposing to the user the set of the selections remaining possible for a variable. In the case of a variable for which the user has not selected a value, that amounts to ‘maintaining coherence’, since it is a matter of presenting the values that are compatible with his/her previous selections. For the variables for which the user has selected at least one value, it is necessary to determine and to present to him/her the possible alternatives for his/her selection that remain compatible with the previous selections, that is to say, the values other than his/her current selection that are compatible with his/her previous selections with respect to this variable.

The device 1 according to the invention that is represented in FIGS. 1 and 2 is intended to permit a human operator 2 (user) to elaborate a definition of a version of a product such as a manufactured product (for example, a version of a car engine to be built) by the sequential selection of values of variables 15, X₁ to X_{N}, subject to predetermined constraints 18, C₁ to C_{M} contained in a data-processing numerical model. The selection is implemented by a human operator by interacting with the device 1 via a man/machine interface which includes, in the preferred embodiment of the invention, an information-communication device 9 (for example, a computer screen) and an information-capture device 8 for (for example, a keyboard and/or a pointing device (mouse)).

The information-communication device may be a screen (television, computer or other) and/or an audio device broadcasting the voice of a human operator and/or a device for speech synthesis or other. The information-capture device may be a tactile screen (television, computer or other), a keyboard, a pointing device, and/or a device for capture by speech dictation or other.

Moreover, advantageously the man/machine interface is suitable to permit a presentation and a selection of values by means of standard navigation software which is run on a computer of the user.

The version of the product is elaborated when each of the questions (or variables 15) of the model includes a response (at least one assigned value). The device 1 ensures that, on this condition, all the incompatibilities with the constraints 18 of the model are displayed (for example, material constraints or techniques of assembly between parts cooperating amongst themselves, or arbitrary constraints defined in the model) and therefore, in particular, that the user can obtain a version of the product that is capable of being fabricated.

The device according to the invention includes means for processing of numerical data having microprocessor(s) and random-access memory/memories associated with the interface 8, 9 and having a bulk memory 3 in which the data that are representative of the model are recorded, notably the values assigned to the variables, for example in the form of a database. The assignment-validation module 4 is suitable to send to the communication device 9 values to be selected for each of the variables 15 (X₁ to X_{N}), assumed in the range of the values V₁ to V_{N} capable of being assigned to each of the variables.

The user 2 effects selections of values with respect to variable Xᵢ by means of the selection device 8 (for example, a keyboard or a computer pointing device). The device 1 according to the invention is suitable so that the selections of the user 2 are sent to the assignment-validation module 4 which analyses the selections, interprets the variables and the corresponding values.

The assignment-validation module 4 determines whether the selection effected by the user 2 satisfies the constraints C₁ to C_{M} of the model. In the negative case, if at least one of the constraints of the model is not complied with, the assignment-validation module 4 sends, by means of the information-communication device 9, a warning message concerning lack of coherence, which is displayed to the user.

For each variable Xᵢ the assignment-validation module 4 interrogates the constraint-verification module 5 in order to receive the range of the compatible values of variable Xᵢ.

The constraint-verification module 5 receives and processes the data that are representative of the variables Xᵢ and applies the constraints Cᵢ to the assigned values Aᵢ of the variables Xᵢ.

The constraint-verification module 5 is suitable to determine, for each variable Xᵢ, its compatible range, that is to say, the subset of the values of this variable that comply with the constraints of the data-processing numerical model 3, by taking account of the assignments effected up until then with respect to the other variables. If variable Xᵢ is not yet assigned, its compatible range is equivalent to the possible values for this variable.

On the other hand, if a value is previously assigned to the captured variable Xᵢ, its compatible range is no longer pertinent, and a new subset of the possible values, called the possible range, has to be determined for this variable. This possible range is constituted by the alternative values of variable Xᵢ that are capable of being selected by a user for said captured variable X, and that are compatible, by application of the constraints, with each previously implemented selection of an assigned value for each other variable, distinct from the captured variable Xᵢ, and ignoring the value assigned previously at the time of a previous selection for said captured variable Xᵢ, including the consequences induced on these compatible values of variable Xᵢ by said previously assigned value, such as are determined by propagation of the constraints via the other variables. In other words, the possible range is formed from the alternative values (different from the previously assigned value) of variable Xᵢ that are compatible with the constraints, this compatibility being determined by disregarding the previously assigned value and its consequences on the other variables.

The device according to the invention is suitable to present to the user via the interface 8, 9, in the course of a step of selection of each variable Xᵢ by said user, at least the possible range of said variable Xᵢ. In order to do this, it is possible to provide that either solely the values of the possible range or, on the contrary, the entirety of the values capable of being assigned to variable Xᵢ be presented to the user, by distinguishing visually those which pertain to the possible range, for example by display, on the screen, of an active button permitting the selection to be implemented by action of the user on a pointer device (mouse) for each value of the possible range, whereas the values that do not pertain to the possible range are not capable of being selected with the pointer device, or again, for example, by leaving the possibility to select any value, possible or not, but by using a particular color for those not possible, in order to signify to the user that these choices would render the current configuration incoherent.

In order to accelerate and to render exhaustive the search for the possible values of a variable Xᵢ, the device 1 according to the invention uses a recording 6 of the state of the assignments of the various variables, which may be in the form of a table or simply in the form of stored values. This recording 6 of the state of the assignments is updated after each assignment of at least one value Aᵢ to a variable Xᵢ, validated by the assignment-validation module 4.

The assignment-validation module 4 displays, via the information-communication device 9, the value(s) assigned to variable Xᵢ, in such a way that the user 2 notes the result of the selection. He/she can then effect a selection with respect to another variable of the model 3, or modify the current assignment of variable Xᵢ or of any other variable Xⱼ assigned previously.

The device 1 according to the invention proposes a sequence of selection of variables Xᵢ that corresponds to a logical progression of a definition of a version of a product. However, the user 2 is not obliged to comply with this order of selection and may just as well configure the model 3 in the order that he/she prefers. Thus, with reference to FIG. 2, if the data-processing device 1 proposes to a user to select sequentially values for the variables X₁ to X_{N} in this order, the user 2 could choose to configure the variables in any different order.

With reference to FIG. 3, the values capable of being assigned to a variable Xⱼ are a function, on the one hand, of the constraints of the model linking several variables and, on the other hand, of the choices of assignments effected previously with respect to the other variables of the model. In the example of a variable Xⱼ not yet assigned, having a range 10 of validity, a constraint Cₘ of the model 3 links, for example, variable Xⱼ and a variable Xᵢ. Thus, when Xᵢ is assigned, Cₘ has the effect of reducing the range of values that Xⱼ can assume to a range 13 of compatible values. Subsequently the assignment 12 of variable Xⱼ is necessarily included in the range 13 of compatible values. If subsequently a user 2 wishes to modify the value(s) assigned to variable Xⱼ, the range 11 of the possible values for this new assignment of variable Xⱼ no longer corresponds to the compatible range 13.

In fact, the possible range 11 may comprise values 14 that might have been prohibited solely on account of the application of constraints stemming from compatible ranges for other modified variables further to the earlier assignment of this variable Xⱼ. On the other hand, this possible range 11 must exclude values 15 rendered prohibited by the application of constraints stemming from the possible assignment of values for other variables.

The device 1 according to the invention permits a user 2 to modify an assignment an unlimited number of times, at any step of the definition of the product, and in identical manner if he/she so wishes.

The definition of a version of a product comprising a very large number of elements may require a great deal of time. Thus, the device 1 according to the invention is suitable to be able to split up the total time for capture of the selections, called the selection session, into a plurality of sessions of use. Such a splitting-up permits the same user to stagger the definition of the product in time. A user 2 initiates a selection session each time he/she commences a new definition of a version of a product on the basis of the model 3. A selection session comes to an end by virtue of the finalizing of the configuration of the model, resulting in a version of the model permitting the fabrication of the product in accordance with this version defined by the user 2. When the user 2 effects selections with respect to only some of the variables and then closes the session and interrupts the device, this latter records the initial data of the model 3 and the data thus assigned to the variables Xᵢ. When the user 2 restarts the device (new session of use), he/she continues the selection session previously initiated and can carry on with selections with respect to variables not yet assigned, or effect modifications with respect to variables assigned in the course of previous sessions of use.

For each new session of use that commences, the device 1 uses the stored assigned data in order to reconstruct the previous session of use in identical manner.

### EXAMPLES

FIG. 4 is a simplified example of a data-processing numerical model permitting the invention to be illustrated and relating to three variables of a vehicle engine: X1 being the power of the engine (90 hp, 110 hp and 140 hp), X2 being the kind of fuel (petrol or diesel), X3 being the type of gearbox (manual or automatic), X4 being the type of steering (non-power-assisted or power-assisted). In this graphic each value capable of being selected for each variable is linked to the various values of the various other variables by links that are representative of the possible choices, that is to say, of constraints.

Table 1 below gives an example of six successive steps (No. 1 to No. 6) of assignment of various values with, after each step, the state of the assignments, the compatible range and the possible range for each variable.

TABLE 1

| | | X1 | | | X2 | | X3 | | X4 | |
|---|---|---|---|---|---|---|---|---|---|---|
| | | 90 hp | 110 hp | 140 hp | Pet | Dies | Man | Auto | NAss | Ass |
| No. 1 | A | | X | | | | | | | |
| | CR | NC(X1) | C | NC(X1) | C | C | NC(X1) | C | C | NC(X1) |
| | PR | P | P | P | P | P | NP(X1) | P | P | NP(X1) |
| No. 2 | A | | X | | | X | | | | |
| | CR | NC(X1, X2) | C | NC(X1) | NC(X2) | C | NC(X1) | C | C | NC(X1) |
| | PR | NP(X2) | P | P | P | P | NP(X1) | P | P | NP(X1) |
| No. 3 | A | | | X | | X | | | | |
| | CR | NC(X1, X2) | NC(X1) | C | NC(X2) | C | C | NC(X1) | NC(X1) | C |
| | PR | NP(X2) | P | P | P | P | P | NP(X1) | NP(X1) | P |
| No. 4 | A | | X | | | X | | | | |
| | CR | NC(X1, X2) | C | NC(X1) | NC(X2) | C | NC(X1) | C | C | NC(X1) |
| | PR | NP(X2) | P | P | P | P | NP(X1) | P | P | NP(X1) |
| No. 5 | A | | X | | | X | | X | | |
| | CR | NC(X1, X2) | C | NC(X1, X3) | NC(X2, X3) | C | NC(X1, X3) | C | C | NC(X1) |
| | PR | NP(X2) | P | NP(X3) | NP(X3) | P | NP(X1) | P | P | NP(X1) |
| No. 6 | A | | X | | | X | | X | X | |
| | CR | NC(X1, X2, X4) | C | NC(X1, X3) | NC(X2, X3) | C | NC(X1, X3) | C | C | NC(X1, X4) |
| | PR | NP(X2, X4) | P | NP(X3) | NP(X3) | P | NP(X1) | P | P | NP(X1) |

A: state of the assignments (X: value assigned to the variable);
CR: compatible range;
PR: possible range;
Pet: value ‘petrol’;
Dies: value ‘diesel’;
Man: value ‘manual’;
Auto: value ‘automatic’
NAss: value ‘non-power-assisted’;
Ass: value ‘power-assisted’;
C: compatible value;
P: possible value;
NC(Xi): non-compatible value, on account, in particular, of variable Xi;
NP(Xi): non-possible value, on account, in particular, of variable Xi.

As can be seen, after each assignment of a variable the compatible range and the possible range of the variables are modified. In addition, at any moment it is possible to change the assignment of a variable while being sure of being compatible with the various constraints.

In step No. 1 the user selects the value ‘110 hp’, which is assigned to variable X1. The other values of this variable become non-compatible but remain possible. In addition, the value ‘manual’ becomes neither compatible nor possible for variable X3, and the same goes for the value ‘power-assisted’ for variable X4.

In step No. 2 the user selects the value ‘diesel’, which is assigned to variable X2. The other value of this variable becomes non-compatible but remains possible. The value ‘90 hp’ which was ‘possible’ up until then, because it was non-compatible only on account of the previous choice 110 hp, is no longer possible for variable X1 because of the choice ‘diesel’ with which it is no longer compatible (incompatibility totally independent of the choice with respect to X1).

In step No. 3 the user selects the value ‘140 hp’, which is assigned to variable X1 in place of the previous one. The other values of this variable become non-compatible, and only the value ‘110 hp’ remains possible. The value ‘automatic’ is no longer compatible or possible for variable X3, on account of this new assignment for variable X1. Similarly, the value ‘non-power-assisted’ is no longer either compatible or possible for variable X4.

In step No. 4 the user again selects the value ‘110 hp’, which is assigned to variable X1. The state of the assignments and the compatible and possible ranges become identical again to those obtained at the conclusion of step No. 2.

In step No. 5 the user selects the value ‘automatic’, which is assigned to variable X3 and which is the only possible value for this variable at this stage. This assignment also renders not compatible (nor possible) the values ‘140 hp’ for variable X1 and ‘petrol’ for variable X2.

In step No. 6 the user selects the value ‘non-power-assisted’, which is assigned to variable X4 and which is the only possible value for this variable at this stage. On account of this assignment, the value ‘90 hp’ is no longer compatible or possible for variable X1, and the value ‘power-assisted’ is no longer compatible for variable X4.

In a device according to the invention the propagation of the constraints can be effected in accordance with any known algorithm. FIG. 5 gives an example of a constraint-verification algorithm known by the term ‘arc coherence’. Step 61 corresponds to the assignment of value Ai to variable Xi which was previously unassigned. In the course of the subsequent step 62 the set of the rules capable of being influenced by this assignment is examined in such a manner as to determine, in the course of step 63, whether there exist values I(Xj) prohibited for other variables Xj linked directly to variable Xi by constraints coming from said variable or linked indirectly to said variable by a chain of constraints, along which prohibitions may be deduced and propagated.

For each of the variables Xj the possible range Aj(Xj) is then deduced in the course of the subsequent step 64.

Afterwards, if a modification of the assignment of variable Xi by a new value Ak replacing value Ai is envisaged (step 65), the constraint-verification module examines in the course of step 67 the set of the rules capable of influencing this variable Xi, that is to say, the constraints entering directly into said variable from the other values Aj≠0 already assigned to the other variables Xj as well as the constraints linked indirectly to this variable by a chain of constraints, as determined in the course of step 66. This examination is effected by taking as assumption that variable Xi is not assigned, that is to say, Ai=0. Depending on this examination, the values I(Xi) prohibited for variable Xi for this modification are determined (step 68), making it possible to deduce, in the course of step 69, the new possible range Ai(Xi) for variable Xi. Thus, the device according to the invention authorizes modifications of assignment of variables in simple and effective manner with only slight calculations and information-processing operations.

The description that follows explains, in more formal and general manner, the way in which a device according to the invention can operate.

A CSP Π is classically defined by a triplet <χ, [symbol] > where χ is a finite set of variables χ={X₁, X₂, . . . , Xₙ}, each variable Xᵢ assuming its values in a finite set D_{Xi}, D=D_{X1} ∪ D_{X2} ∪ . . . ∪ D_{Xn} and by a finite set of constraints C. A constraint C of C, defined on V(C) ⊂ χ, restricts the combinations of values that the variables V(C) can assume which appear in C. With each constraint C there is associated a relation R(C) included in the Cartesian product of the ranges of the variables of V(C): it is the set of the tuples that satisfy it. An assignment s is a tuple of D_{X1}×D_{X2}× . . . ×D_{Xn}; it is a solution of the CSP if it satisfies all the constraints, that is to say, if, for any constraint C, the projection of s onto V(C) is in R(C) (if not, it is said that it falsifies C). S(Π) designates the set of the solutions of Π. There is [symbol] C the constraint on V(C) satisfied by any assignment that falsifies C and falsified by any assignment that satisfies C. Π is called coherent if it possesses a solution, otherwise it is called incoherent.

Definition 1:

An H-CSP Π is a quadruplet <χ, [symbol] C, [symbol] > where <χ, [symbol] C> is a CSP and [symbol] a finite set of constraints such that V( [symbol] ) ⊂ χ.

In the course of use of a device according to the invention, <χ, [symbol] C> represents the product and [symbol] the current selections of the user.

An assignment s is a solution of Π if s is a solution of Π′=<χ, [symbol] C∪ [symbol] >, the CSP associated with Π.

Π is called coherent (respectively, incoherent) if Π′ is coherent (respectively, incoherent). At any instant the set of the solutions of Π corresponds to the set of all the products complying with the restrictions laid down by the user. For any variable Xᵢ, there is S(Π)[Xᵢ], the projection of S(Π) on Xᵢ. It is the set of all the values of Xᵢ permitting a product to be defined complying with the constraints [symbol] .

In the following, the sets [symbol] ⊂ [symbol] of assumptions are called environments, whether or not they are coherent.

Definition 2:

Let Π be an H-CSP. An environment is called coherent (respectively, incoherent) with Π if and only if <χ, [symbol] C∪ [symbol] > is a coherent (respectively, an incoherent) CSP.

An incoherent environment is called a conflict of Π (or a conflict of [symbol] for C).

When <χ, [symbol] C> is coherent, a conflict may be understood as a cause of the incoherence of the H-CSP<χ, [symbol] C, [symbol] > (for example, of the incoherence of the selections of the user with the constraints), and any coherent environment defines a subset of constraints of [symbol] the relaxation of which restores the coherence: if [symbol] is a coherent environment, it is sufficient for the user to relax [symbol] \ [symbol] .

For example, if <χ, [symbol] C> is coherent and <χ, [symbol] C, [symbol] > is incoherent, [symbol] is a trivial conflict, Ø is a coherent environment, and a naïve solution is the relaxation of all the constraints of [symbol] This example also shows that not all the environments are equally of interest: typically the coherent (respectively, incoherent) environments are preferred that are maximal (respectively, minimal) for the set-theoretical inclusion.

Definition 3:

A prohibition for C on [symbol] (or prohibition of Π) is a conflict [symbol] of Π such that there exists no conflict [symbol] ′ of Π such that [symbol] ′ ⊂ [symbol] . One interpretation of Π is a coherent environment [symbol] of Π such that there exists no coherent environment [symbol] ′ of Π such that [symbol] ⊂ [symbol] ′.

Even if the set of the current selections of the user is not incoherent, the values remaining within the ranges of the variables may no longer suit the user. It is then necessary to be able to explain to him/her why some value or other is no longer authorized, that is to say, to present to him/her the minimal configurations that exclude it. This calls for a notion of explanation, defined in all generality (that is to say, without making the assumption that the H-CSP being considered is coherent).

Definition 4:

Let Π=<χ, [symbol] C, [symbol] > be an H-CSP and let [symbol] be a constraint on variables of χ. An explanation of [symbol] in Π is an environment [symbol] such that <χ, [symbol] C∪ [symbol] > is coherent and <χ, [symbol] C∪ [symbol] ∪ { [symbol] [symbol] }> is incoherent. [symbol] is a minimal explanation of [symbol] in the H-CSP if it is minimal for the set-theoretical inclusion.

To determine in which circumstances a selection [symbol] is prohibited is to determine with which set of current selections [symbol] is incoherent, that is to say, to calculate explanations of

[symbol]

[symbol]

If the user needs explanations of the prohibition of [symbol] , he especially needs to know which previous assignments to release (that is to say, to modify) in order to authorize [symbol] . The dual notion of the explanation of a constraint is the notion of restoration.

Definition 5:

Let Π=<χ, [symbol] C, [symbol] > be an H-CSP and let [symbol] be a constraint on variables of χ.

A restoration of [symbol] is an environment [symbol] such that <χ, [symbol] C∪ [symbol] ∪ { [symbol] [symbol] } is a coherent CSP. [symbol] is maximal if it is maximal for the inclusion (in the sense of the algebra of sets).

It is to be noted that the restorations may be considered as the coherent environments of the H-CSP that is obtained by adding [symbol] to C.

In the course of the use of a device according to the invention a search for prohibitions is only activated when it has been determined that the H-CSP being considered is incoherent (that is to say, C∪ [symbol] is incoherent); a search for explanations of [symbol] [symbol] is only activated when it has been determined that the H-CSP being considered is coherent (that is to say, C∪ [symbol] is coherent) and that [symbol] is not authorized, taking account of the current selections [symbol] (that is to say, C∪ [symbol] ∪ [symbol] is incoherent); one only seeks to restore a [symbol] when it has been determined that it is possible at the outset (that is to say, C∪ [symbol] is coherent).

Determination of the Possible Range:

Within the scope of the use of a device according to the invention the following assumptions may be laid down: C is coherent, [symbol] is coherent, [symbol] is a finite set of unary constraints relating to variables that are different from one another (they may be otherwise trivially merged, in order to form only one therefrom), and the various [symbol] considered are also unary constraints.

Definition 6:

Let Π=<χ, [symbol] C, [symbol] > be an H-CSP, with [symbol] a set of unary constraints on V(H) ⊂χ.

It is said that v is the value selected for Xᵢ if there exists C∈ [symbol] a value-selection constraint for Xi such that V(C)={Xᵢ} and R(C)={v}. It is said that v is the selection induced for Xᵢ if v is not a selected value and v is the sole value of S(Π)[Xᵢ].

Even if the set of the current selections is not incoherent, the values selected by the user may not suit him/her, and he/she may wish to change some of these values. It is then necessary to be able to propose to him/her, for each selection, the set of the possible alternatives, that is to say, the set of the other possible values that remain coherent with the other assignments.

Definition 7:

Let Π=<χ, [symbol] C, [symbol] > be an H-CSP, with [symbol] a set of unary constraints on V( [symbol] ) ⊂χ.

For each variable Xᵢ of χ the range of the possible values for Xᵢ is defined as D_{Xi} if Xᵢ has no assigned value, as S(Π)[<χ, [symbol] C, [symbol] −C>] if C is the selection constraint for Xᵢ.

With the example of FIG. 4, supposing that the user selects, first of all, a diesel car and opts afterwards for a power of 110 hp for his/her vehicle:
the 90 hp option is then a prohibited value, since it is not compatible with the selection of a diesel vehicle. Therefore this is not a possible value, the change from 110 hp to 90 hp would lead the system to an inconsistent state.
the 140 hp option is a possible value for the power, which remains compatible with the other assignments effected. The change from 110 hp to 140 hp would leave the system in a coherent state.

The user is not, in general, capable of apprehending a large number of conflicts, of coherent environments, of explanations or of restorations. In a situation of inconsistency, even if it is possible to present to him/her a subset of the possible explanations (exponential in number) he/she generally opts for a natural approach consisting in modifying his/her previous choices. Within this scope it is necessary to guide him/her by proposing to him/her the set of the coherent alternatives and by avoiding passage into a situation of inconsistency. In other words, it is a matter of guiding the user by presenting, for each question that has been answered as a prohibited value, the only values, the prohibition of which can be explained without using the current response to said question. In other words, the device according to the invention will authorize as alternative choices for a question the set of the selections that would have been possible if he/she had not selected this response for the question.

Maintenance of Coherence.

The maintenance of coherence in the course of the use of a device according to the invention consists in applying to the CSP, upon each introduction of an assumption by the user, a procedure for filtering and for reinforcement of coherence, identifying in the range of the variables which values can no longer pertain to a solution because they have become incompatible with the new assumption.

Definition 8:

Let Π=<χ, [symbol] C, [symbol] > be an H-CSP, and C [symbol] a constraint on the variables of χ.

A filtering procedure transforms Π into an H-CSP (Π,C)=Π′=<χ, [symbol] ′, C′, [symbol] +C> such that S(Π)=S(Π′) and, for any variable Xi of χ, D′_{Xi}⊂D_{Xi} is the new filtered range for Xi. The values of D_{Xi}−D′_{Xi} are said to be prohibited.

In the course of the use of a device according to the invention incorporating a filtering procedure . which consists of successive additions of assumptions by the user, each interaction is automatically followed by a reinforcement of coherence by use of . in order to determine the possible new prohibited values.

The filtering procedure that is used must be sufficiently fast to remain compatible with an interactive use in real time. It must also ensure a level of coherence that is as high as possible. It preferably guarantees that all the remaining authorized values after filtering pertain to at least one solution. These two objectives are orthogonal, except for particular classes of problem, the reinforcement of the global coherence of a CSP remains an NP-hard problem (cf. for example, Romuald Debruyne “Les algorithmes d'arc-consistance dans les CSP dynamiques”, Revue d'Intelligence Artificielle, 9(3), 1995).

Definition 9:

Let Π=<χ, [symbol] C > be a CSP, an instantiation I of [symbol] ={Xi₁,Xi₂, . . . , Xiₖ} ⊂ χ is an application of I of [symbol] in [symbol] such that I(Xiⱼ) ∈ D_{Xij}

If [symbol] =χ, the instantiation is called complete, otherwise it is called partial. The instantiation is called coherent (respectively, incoherent) if it respectively does not comply with the set of the constraints, that is to say, if the H-CSP<χ, [symbol] C, {( [symbol] ,I)}> is a coherent (respectively, an incoherent) CSP.

An instantiation I′ of [symbol] ′ extends I if and only if [symbol] ⊂ [symbol] ′ and for all Xiⱼ ∈ [symbol] I(Xiⱼ)=I′(Xiⱼ).

Definition 10:

Let Π be a CSP. If any coherent partial instantiation can be extended to a solution (that is to say, to a coherent complete instantiation), then Π is said to be globally coherent.

In the case of a non-global filtering procedure, the set of the possible values for a variable is redefined as follows.

Definition 11:

Let us consider a CSP Π=<χ, [symbol] C> and [symbol] =[H₁, H₂, . . . Hₖ] a sequence of assumptions corresponding to successive choices of the user in ascending order of the indices of the assumptions, and a filtering procedure.

There is .Π, [symbol] )=Π′=<χ, [symbol] ′, C′, [symbol] >, the CSP with assumption ( . . . (((<χ, [symbol] C, Ø>,H₁), H₂), . . . Hₖ) obtained by adding and filtering successively the set of the assumptions of [H₁, H₂, . . . Hₖ] to <χ, [symbol] C>.

For each variable Xᵢ of χ the range of the possible values for Xᵢ is the range of Xi in .Π, [symbol] ) if Xᵢ has no assigned value, otherwise it is the range of Xi in .Π, [symbol] −C) or C is the selection constraint for Xᵢ.

If is a filtering method reinforcing the global coherence of the CSP, then the possible values for a variable are those defined by Definition 7, since, by definition, any remaining value for the range of Xi in .Π, [symbol] −C) pertains to a solution. Otherwise the range of the possible values in relation to the procedure contains that of Definition 7.

Refutation and Annulment of Propagation.

Let us consider a CSP Π=<χ, [symbol] C> and [symbol] =[H₁, H₂, . . . Hₙ] a sequence of assumptions corresponding to successive selections of the user in ascending order of the indices of the assumptions.

Let Hₖ be one of the selections of the user. If the user wishes to release his/her selection Hₖ, it is necessary to suppress all the consequences induced directly (at the moment of its introduction) or indirectly (at the moment of the introduction of the later selections the filtering is based on the current assumptions which take account of this selection) by this selection. Several methods permit this problem to be resolved, for example a procedure of chronological refutation. This procedure consists in removing the set of the assignments effected since Hₖ (included), and then in reintroducing the following selections, that is to say, the assumptions Hₖ₊₁ . . . Hᵢ.

There is Πᵢ, the CSP (Π,[H₁, H₂, . . . Hᵢ]) obtained after successive additions of the i first assumptions.

There is Π_{i\k}, the CSP ((~( . . . (((Π,H₁), H₂), . . . Hₖ₋₁), Hₖ₊₁) . . . Hᵢ) obtained by withdrawing Hₖ from the set of the assumptions of Πᵢ.

It is easily noticed that Π_{i\i=}Πᵢ₋₁, from which it follows that Π_{i\{i, i-1}}=Πᵢ₋₂ and, by recursion, Π_{i\{i,i-1, . . . k}}=Πₖ₋₁. From this, it is derived that Π_{i\k} is written ( . . . ((Πₖ₋₁, Hₖ₊₁), . . . Hᵢ).

In practice, a device according to the invention records, in the course of use, either the successive Πₖ or the modifications δⱼ=Πⱼ−Πⱼ₋₁.

Whatever the method retained, it is easily possible to be brought back to Πₖ₋₁, either because it has been stored or because it can be reconstructed from Πᵢ: Πₖ₋₁=Πᵢ+δᵢ+δᵢ₋₁+ . . . +δₖ

Calculation of the Possible Values:

The possible values are those which the user can select as replacement for one of his/her earlier selections and which are compatible with the remaining values. It is therefore a matter, in other words, of the set of the values that would be authorized if said user had not yet made this selection but had made all the other selections.

Consequently, the calculation of the possible values can be effected in the following manner.

Inputs:
Y={X₁, X₂, . . . , Xᵢ} a set of instantiated variables,
{H₁, H₂, . . . , Hᵢ} the set of the selections of the user U.

Output:
A={D_{α1}, D_{α2}, . . . , D_{αi}}: the set of the associated possible ranges.

Instructions:
Store Πᵢ
For all Xₖ Y
Calculate Π_{i\k}=( . . . (Πₖ₋₁, Hₖ₊₁), . . . Hᵢ)
Store D_{αk}=D(Xₖ) in Π_{i\k}
Restore Πᵢ
End
Return A={D_{α1}, D_{α2}, . . . , D_{αi}}

Whatever the approach used for the constraint withdrawal, this process permits the possible values to be calculated. Furthermore, in order to optimize the times of calculation of the possible values (determinant in configuration), the calculation of these values may be subjected either to an explicit request of the user or, since the process permits this, to an implicit request: all the values currently displayed.

The invention may be the object of very numerous variants in relation to the embodiments and examples represented in the Figures and described above solely for purposes of illustration.

1. Device for formulating a combination of numerical data that is representative of a version of a product having variants and options, on the basis of a numerical model that is representative of a plurality of versions of said product, said data-processing numerical model comprising functional components, variables and constraints, said device comprising:
at least one man/machine interface,
stored data that are representative of a plurality of predetermined variables with respect to which assignments have to be effected,
for each variable, stored data that are representative of a plurality of values capable of being assigned to this variable by selection by a human operator via said man/machine interface independently of the constraints linked to assignments implemented previously,
stored data, called the state of the assignments, that are representative at each instant of the values already assigned at this instant to variables,
stored data that are representative of predetermined constraints,
a constraint-verification module (5) that is suitable to determine, from said data that are representative of said predetermined constraints, and for each variable, the range, called the compatible range, of the values, called the compatible values, capable of being selected for said variable without infraction of said constraints,
wherein:
the constraint-verification module (5) is also suitable to determine, at least before each selection by a human operator for a variable, called the captured variable, a set, called the possible range, of values, called the alternative values, capable of being selected by a human operator for said captured variable and compatible, by application of said predetermined constraints, with each assignment of a value for each other variable, distinct from the captured variable, this determination being implemented on the basis of said state of the assignments and by application of said predetermined constraints for each other variable that is distinct from the captured variable, and, ignoring whether it exists, the value assigned at the time of a previous selection for said captured variable,
the device is suitable to present, via the man/machine interface (8,9), said possible range for each selection of a variable.

2. Device as claimed in claim 1, wherein the constraint-verification module (5) is suitable to define the possible range by determining the compatible values of the captured variable, ignoring:
on the one hand, the value assigned at the time of a previous selection for said captured variable,
on the other hand, the consequences induced on the compatible or possible ranges of the other variables by propagation of constraints, triggered by this previous assignment.

3. Device as claimed in claim 1, wherein the constraint-verification module (5) is suitable, after each assignment of a value for a captured variable, to update the possible range of each other variable by propagation of the constraints, step by step, to all the variables linked by at least one constraint to the captured variable.

4. Device as claimed in claim 1, wherein it includes an assignment-validation module (4) that is suitable to be able to:
record, as value assigned to the captured variable, any selection for the captured variable effected within the possible range,
determine whether the assignment of a value for a captured variable satisfies said predetermined constraints and, in the negative, produce a warning message via the man/machine interface.

5. Device as claimed in claim 1, wherein the assignment-validation module (4) is suitable to permit several successive modifications of a value assigned to a captured variable.

6. Device as claimed in claim 2, wherein the constraint-verification module (5) is suitable, after each assignment of a value for a captured variable, to update the possible range of each other variable by propagation of the constraints, step by step, to all the variables linked by at least one constraint to the captured variable.

7. Device as claimed in claim 2, wherein it includes an assignment-validation module (4) that is suitable to be able to:
record, as value assigned to the captured variable, any selection for the captured variable effected within the possible range,
determine whether the assignment of a value for a captured variable satisfies said predetermined constraints and, in the negative, produce a warning message via the man/machine interface.

8. Device as claimed in claim 3, wherein it includes an assignment-validation module (4) that is suitable to be able to:
record, as value assigned to the captured variable, any selection for the captured variable effected within the possible range,
determine whether the assignment of a value for a captured variable satisfies said predetermined constraints and, in the negative, produce a warning message via the man/machine interface.

9. Device as claimed in claim 6, wherein it includes an assignment-validation module (4) that is suitable to be able to:
record, as value assigned to the captured variable, any selection for the captured variable effected within the possible range,
determine whether the assignment of a value for a captured variable satisfies said predetermined constraints and, in the negative, produce a warning message via the man/machine interface.
